(19) United States
(12) Patent Application Publication
(10) Pub. No.: US 2007/0212040 A1
(43) Pub. Date: Sep. 13, 2007

(54) PHOTOGRAPHIC DEVICE WITH ANTI-SHAKE FUNCTION

(75) Inventor: Kosei Kosako, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/681,826

(22) Filed: Mar. 5, 2007

(30) Foreign Application Priority Data
Mar. 7, 2006 (JP) 2006-061090

(51) Int. Cl. G03B 17/00

(52) U.S. Cl. 396/55

(57) ABSTRACT

A photographic device, according to the present invention, includes a shake detector, a shake mitigator, a shake controller, and a battery charge detector. The shake detector detects a device shake that is a shake of the photographic device. The shake mitigator mitigates an effect of the device shake to reduce an image shake that is a shake of a photographed subject image. The shake controller controls the shake mitigator. The battery charge detector detects the charge remaining in a battery of the photographic device. The shake controller controls the shake mitigator so that the shake mitigator mitigates the effect of the device shake only when the detected charge remaining in the battery is larger than a standard charge.

### BACKGROUND OF THE INVENTION

1. Field of the Invention

The present invention relates to a photographic device that has an anti-shake function, especially to a photographic device where the anti-shake function is controllable.

2. Description of the Related Art

Photographic devices, such as cameras, which have an anti-shake function to prevent a shake in a generated subject image have become widespread. In digital cameras, for example, anti-shake functionality is achieved by moving an imaging device or a photographing lens, or by other methods.

When an image shake is mitigated, driving an imaging device or a photographing lens and so on, are required, thus increasing the amount of power consumption. Therefore, if the anti-shake function is not controlled and the amount of the residual charge of a battery in the photographic device is low, conducting necessary operations which consume large amount of power may be impossible.

### SUMMARY OF THE INVENTION

Therefore, the objective of the present invention is to provide a photographic device with an anti-shake function that can correct an image shake and can prolong the battery life.

A photographic device, according to the present invention, includes a shake detector, a shake mitigator, a shake controller, and a battery charge detector. The shake detector detects a device shake that is a shake of the photographic device. The shake mitigator mitigates an effect of the device shake to reduce an image shake that is a shake of a photographed subject image. The shake controller controls the shake mitigator. The battery charge detector detects the charge remaining in a battery of the photographic device. The shake controller controls the shake mitigator so that the shake mitigator mitigates the effect of the device shake only when the detected charge remaining in the battery is larger than a standard charge.

### BRIEF DESCRIPTION OF THE DRAWINGS

The present invention will be better understood from the description of the preferred embodiment of the invention set forth below, together with the accompanying drawings in which:

FIG. 1 is a block diagram of a digital camera of an embodiment of the present invention; and

FIG. 2 is a flowchart of a shake mitigation control routine.

### DESCRIPTION OF THE PREFERRED EMBODIMENT

Hereinafter, the embodiment of the present invention is described with reference to the attached drawings.

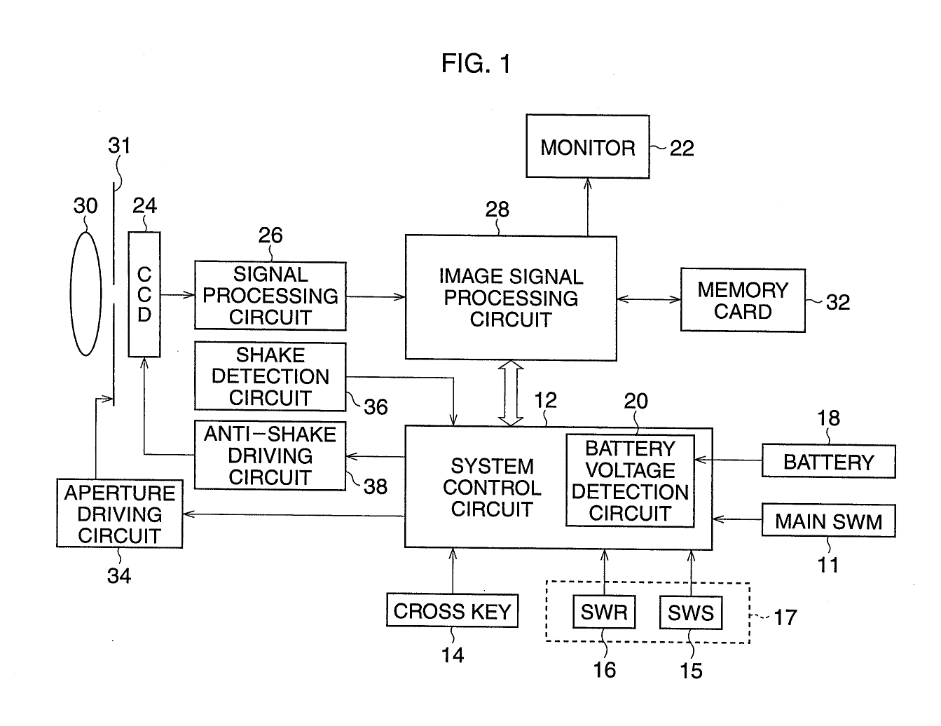

As shown in FIG. 1, in a digital camera of this embodiment, a system control circuit 12 that controls the entire digital camera is provided. The digital camera has a main switch SWM 11. When the main switch SWM 11 is turned on by an operation of a user, the system control circuit 12 starts. Connected to the system control circuit 12, are a cross key 14, a photometry-measuring switch (SWS) 15, a release switch (SWR) 16, and so on. Signals corresponding to operations of these switches are transmitted to the system control circuit 12.

In the digital camera, a battery 18 is provided for supply of required electric power. In the system control circuit 12, a battery voltage detection circuit 20 (a battery charge detector) to detect the battery voltage of the battery 18, is provided. The charge remaining in the battery 18 is detected by the battery voltage detection circuit 20, based on the battery voltage.

In the digital camera, a capture mode in which a subject is photographed and a still image of a subject is generated, a replay mode in which a photographed subject image is replayed, and other modes can be set by an operation of a mode dial and so on (not shown). Further, in the digital camera, a monitor 22 to display a subject image is provided. When the capture mode is set, a subject image is displayed on the monitor 22 as a through image, before a still image is generated, as explained below.

First, a CCD 24 (an imaging device) receives reflected light from a subject through a photographing lens 30. As a result, electric charges corresponding to a subject are generated in the CCD 24. The sensitivity of the CCD 24 is adjusted by the system control circuit 12 (a sensitivity adjuster). The electric charges generated by the CCD 24, that is, the image signals, are transmitted to a signal processing circuit 26. At the signal processing circuit 26, image signals are processed to reduce noise, and are converted from analog signals to digital signals. The processed image signals are then transmitted to an image signal processing circuit 28.

In the image signal processing circuit 28, various processes are carried out on the digital image signals, such as white balance adjustment, gamma correction, and so on, and then luminance signals and color-difference signals are generated. The generated luminance signals and color-difference signals, that is, the image data, are then transmitted to the monitor 22. As a result, a subject image is displayed on the monitor 22 as a through image.

When the release button 17 is half-depressed, the photometry-measuring switch 15 that is connected to the system control circuit 12 is turned on. When the photometry-measuring switch 15 is on state, distance-measuring operations by a distance measurement element and photometric operations by a photometry measurement element (both not shown) are carried out. Obtained distance data and photometry data are then transmitted to the system control circuit 12, which controls a focusing operation based on the distance data, and calculates an exposure value based on the photometry data.

When the release button 17 is fully depressed, the release switch 16 is turned on, and then the shutter speed of the electronic shutter of the CCD 24 and an aperture value for an aperture 31 are set by the system control circuit 12. As a result, the aperture 31 is opened a predetermined amount under the control of an aperture driving circuit 34, and the CCD 24 is exposed for a predetermined amount of time. A still image is generated based on the image signals read from the CCD 24, and displayed on the monitor 22. The image data of the still image are stored in a memory card 32.

In the digital camera, a shake detecting circuit 36 (a shake detector) that detects a shake of the digital camera is provided. In the shake detecting circuit 36, a gyro sensor, a high-pass filter, and other elements (none of which are shown) are provided. The shake detecting circuit 36 detects a shake by a known method. From the shake detecting circuit 36, signals representing the magnitude of the detected shake are transmitted to the system control circuit 12.

Based on the signals output from the shake detecting circuit 36, the system control circuit 12 transmits order signals to an anti-shake driving circuit 38 (a shake mitigator) to control the CCD 24 for shake reduction. The CCD 24 is slightly driven, that is, the CCD 24 is slightly moved in a direction perpendicular to the optical axis of the photographing lens 30 by a predetermined amount by the anti-shake driving circuit 38 to mitigate the effect of a shake of the digital camera on a photographed subject image. As a result, the impact of a shake of the digital camera is mitigated or canceled out by the movement of the CCD 24, and an image with a subject that has not been shaken, can be generated.

Note that shake mitigation by the shake detecting circuit 36 and the anti-shake driving circuit 38 is carried out by the operation of the cross key 14 (a shake mitigation commander), in principle. That is, when a menu screen is displayed by the operation of a menu button (not shown) on the monitor 22, and the cross key 14 is operated, the shake detecting circuit 36 and the anti-shake driving circuit 38 are activated.

However, although shake mitigation is commanded by the cross key 14, when the detected charge remaining in the battery 18 is less than or equal to the predetermined minimum remaining charge (a standard charge), shake mitigation of the digital camera is not carried out. That is, regardless of the command for shake mitigation, the shake detecting circuit 36 and the anti-shake driving circuit 38 are controlled to cease functioning by the system control circuit 12 (a shake controller), when it is determined that the charge remaining in the battery 18 is less than or equal to the minimum remaining charge. The purpose of this control is to prolong the life of the battery 18 by using other methods for mitigating shake of the digital camera, as explained below.

When shake mitigation is not carried out, regardless of the command, an icon indicating the fact is displayed on the monitor 22 (an alarm, an indicator) under the control of the system control circuit 12. Therefore, it is possible to alarm a user when commanded shake mitigation is not carried out.

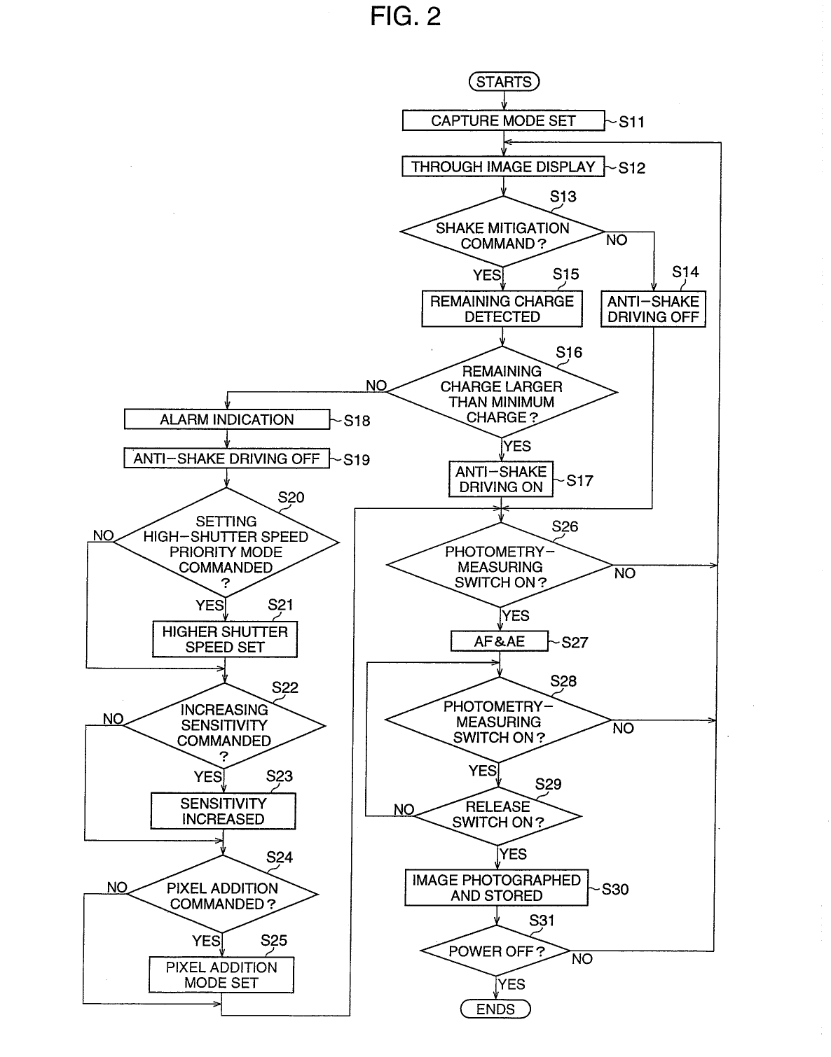

The shake mitigation control routine (see FIG. 2) starts when the main switch 11 of the digital camera is turned on. At step S11, the capture mode is set, and the process proceeds to step S12. At step S12, a through image is displayed on the monitor 22, then the process proceeds to step S13. At step S13, it is determined whether or not shake mitigation of the digital camera is commanded by the operation of the cross key 14; when it is determined shake mitigation is not commanded, the process proceeds to step S14, but when it is determined that shake mitigation is commanded, the process proceeds to step S15.

At step S14, the shake detecting circuit 36 and the anti-shake driving circuit 38 are turned off, then the process proceeds to step S26. On the other hand at step S15, the charge remaining in the battery 18 is detected, then the process proceeds to step S16. At step S16, it is determined whether or not the detected charge remaining in the battery 18 is larger than the minimum remaining charge; when it is determined that the remaining charge is larger than the minimum remaining charge, the process proceeds to step S17, but when it is determined that the remaining charge is less than or equal to the minimum remaining charge, the process proceeds to step S18. At step S17, the anti-shake driving circuit 38 and so on, are turned on, then the process proceeds to step S26.

At step S18, the alarm indication is displayed on the monitor 22, then the process proceeds to step S19. At step S19, the anti-shake driving circuit 38 and so on, are turned off, then the process proceeds to step S20. From steps S20 to S25, operations effecting the mitigation of image shake are carried out based on the command from a user, instead of being controlled by the anti-shake driving circuit 38.

At step S20, it is determined whether or not a command has been made to set a high-shutter speed priority mode for exposure control; when it is determined that the command for setting high-shutter speed priority mode is made, the process proceeds to step S21, otherwise, the process proceeds to step S22. In the high-shutter speed priority mode set at step S21, higher electronic shutter speeds are set by the system control circuit 12 (a shutter speed setter) for the CCD 24 than when the anti-shake driving circuit 38, and so on, function to mitigate shake.

At the time, in addition to the electronic shutter speed of the CCD 24 being controlled to be higher than that under the shake mitigation operation, the aperture value of the aperture 31 is controlled by the aperture driving circuit 34 to be smaller than that under the shake mitigation operation. As a result, in the high-shutter speed priority mode, the exposure amount is the same, under the same conditions, as in the case where the anti-shake driving circuit 38 and so on, mitigate the device shake.

At step S22, it is determined whether or not increasing the ISO sensitivity of the CCD 24 is commanded; when it is determined that increasing the ISO sensitivity of the CCD 24 is commanded, the process proceeds to step S23, otherwise, the process proceeds to step S24. At step S23, the ISO sensitivity is adjusted by the system control circuit 12 (a sensitivity adjuster) to be higher, under the same conditions, than that set in the case where the anti-shake driving circuit 38 and so on, mitigate the device shake. The process then proceeds to step S24.

At step S24, it is determined whether or not a command has been made to set a pixel addition mode for reading electric charge from the CCD 24; when it is determined that the command for setting the pixel addition mode is made, the process proceeds to step S25, otherwise, the process proceeds to step S26. In pixel addition mode set at step S25, the electric charges of four pixels adjacent to each other in the horizontal and vertical directions of the CCD 24, are added together and read. As a result of the pixel addition operation, the sensitivity of the CCD 24 is improved, compared to that when the anti-shake operation is carried out.

Note that the high-shutter speed priority mode set at step S21, and the sensitivity adjustments carried out at steps S23 and S25, are commanded by the operations of the menu button, the cross key 14, or so on, similarly to commanding the shake mitigation by the anti-shake driving circuit 38 and so on. Due to setting the high-shutter speed priority mode or increasing the sensitivity of the CCD 24, an image shake is mitigated without utilizing the anti-shake driving circuit 38 and so on.

At step S26, it is determined whether or not the photometry-measuring switch 15 is on state; when it is determined that the photometry-measuring switch 15 is on state, the process proceeds to step S27, otherwise, the process returns to step S12. At step S27, focusing control and exposure control are carried out, and the process proceeds to step S28.

At step S28, it is again determined whether or not the photometry-measuring switch 15 is on state; when it is determined that the photometry-measuring switch 15 is on state, the process proceeds to step S29, otherwise, the process returns to step S12. At step S29, it is determined whether or not the release switch 16 is on state; when it is determined that the release switch 16 is on state, the process proceeds to step S30, otherwise, the process returns to step S28.

At step S30, a subject is photographed and a generated still subject image is stored in a storage medium such as the memory card 32. The process next proceeds to step S31, where it is determined whether the power source for the digital camera is on or off. When it is determined that the power source for the digital camera is on state, the process returns to step S12; otherwise, the shake mitigation control routine ends.

As explained above, in this embodiment the anti-shake operation by the anti-shake driving circuit 38, and so on, can be carried out only when the charge remaining in the battery 18 is sufficient; otherwise it is more effective to use alternative methods for mitigating an image shake that do not consume excess power when the charge remaining in the battery 18 is deficient. Therefore, the life of the battery 18 can be prolonged.

Although only a digital camera is exemplified in this embodiment, the anti-shake mechanism is not limited to use with a digital camera. For example, the anti-shake mechanism may be adapted to a silver-halide film camera or other photographic device. In a case where the anti-shake mechanism is adapted to a silver-halide film camera, adjusting the sensitivity of a CCD is unique to a digital camera and not applicable. Nevertheless, the anti-shake operation is controlled according to the charge remaining in a battery, and a mechanical shutter is adjusted when the anti-shake operation is not carried out, essentially similar to the present embodiment.

Setting the high-shutter speed priority mode, increasing the ISO sensitivity of the CCD 24, and setting the pixel addition mode (see steps S20-S25) may be automatically carried out under the control of the system control circuit 12 without any command, although they are carried out based on a command of a user in the present embodiment. In such a case, adjusting the shutter speed and the sensitivity of the CCD 24 may be carried out selectively, or in combination with each other.

The charge remaining in the battery 18 may be detected after the focus control and exposure control are carried out at step S27. In this case, setting the high-shutter speed priority mode, increasing the ISO sensitivity of the CCD 24, and setting the pixel addition mode can be carried out according to the subject and photographing conditions, such as a set mode, of the situation. Also in this case, adjusting shutter speed and sensitivity of the CCD 24 may be carried out selectively, or in combination with each other.

The alarming method for alarming the shake of the digital camera is not mitigated, regardless of a shake mitigation command, and is not limited to an icon display in the embodiment. For example, a warning message may be displayed on the monitor 22. Further, although alarms on the monitor 22 are preferable because a user frequently watches the monitor 22 during the operation of a digital camera, the alarm method is not limited to monitor-based alarms. For example, an audio alarm by a voice from the digital camera may be adapted.

The method of shake mitigation is not limited to the driving of the CCD 24 by the anti-shake driving circuit 38 and other elements that are adopted in this embodiment; for example, driving the photographing lens 30 and so on may also be used to reduce the effect of a shake on a subject image.

This invention is not limited to that described in the preferred embodiment, namely, various improvements and changes may be made to the present invention without departing from the spirit and scope thereof.

The present disclosure relates to subject matter contained in Japanese Patent Application No. 2006-061090 (filed on Mar. 7, 2006), which is expressly incorporated herein, by reference, in its entirety.

1. A photographic device comprising:
a shake detector that detects a device shake that is a shake of said photographic device;
a shake mitigator that mitigates the effect of said device shake to reduce an image shake that is a shake of a photographed subject image;
a shake controller that controls said shake mitigator; and
a battery charge detector that detects the charge remaining in a battery of said photographic device;
said shake controller controlling said shake mitigator so that said shake mitigator mitigates said device shake only when the detected charge remaining in said battery is larger than a standard charge.

2. The photographic device according to claim 1, further comprising a shake mitigation commander that commands said shake mitigator to mitigate the effect of said device shake, and an alarm that alarms when said shake mitigator does not mitigate said device shake, regardless of a shake mitigation command.

3. The photographic device according to claim 2, wherein said alarm comprises an indicator that indicates when said shake mitigator does not mitigate said device shake.

4. The photographic device according to claim 1, further comprising a shutter speed setter that sets a shutter speed of said photographic device, said shutter speed setter setting a higher shutter speed when said shake controller controls said shake mitigator not to mitigate the effect of said device shake, than when said shake mitigator mitigates the effect of said device shake.

5. The photographic device according to claim 4, wherein said shutter speed setter sets said shutter speed when said shake controller controls said shake mitigator not to mitigate the effect of said device shake, so that the exposure amount is the same as that when said shake mitigator mitigates the effect of said device shake.

6. The photographic device according to claim 4, wherein said photographic device is a digital camera comprising an imaging device that receives light from a subject, said shutter speed setter setting a shutter speed of the electronic shutter of said imaging device.

7. The photographic device according to claim 1, wherein said photographic device is a digital camera comprising an imaging device that receives light from a subject, and a sensitivity adjuster that adjusts the sensitivity of said imaging device, said sensitivity adjuster adjusting the sensitivity to be higher when said shake controller controls said shake mitigator not to mitigate the effect of said device shake than when said shake mitigator mitigates the effect of said device shake.

8. The photographic device according to claim 7, wherein said sensitivity adjuster adjusts the ISO sensitivity of said imaging device.

9. The photographic device according to claim 7, wherein said sensitivity adjuster adjusts said sensitivity, according to whether pixel addition of said imaging device is carried out or not.
